(19) United States
(12) Patent Application Publication
(10) Pub. No.: US 2016/0288175 A1
(43) Pub. Date: Oct. 6, 2016

(54) CLEANING DEVICE

(71) Applicant: Nilfisk A/S, Brondby (DK)

(72) Inventor: Lars Therkildsen, Hadsund (DK)

(21) Appl. No.: 15/037,522

(22) PCT Filed: Nov. 10, 2014
(86) PCT No.: PCT/DK2014/050377

§ 371 Date: May 18, 2016

(30) Foreign Application Priority Data
Nov. 20, 2013 (DK) PA 2013 70711

(51) Int. Cl. B08B 3/02; B63B 59/08; B05B 3/06

(52) U.S. Cl. CPC B08B 3/024; B05B 3/06; B63B 59/08

(57) ABSTRACT

A cleaning device contains a cleaning nozzle unit with at least one nozzle having an exit channel with a nozzle opening. The unit is mounted on a rotary shaft having a longitudinal axis and a direction of rotation and the cleaning device further includes a propeller mounted on the rotary shaft. The propeller has at least one plate shaped vane with a first plate part having a leading edge with a length and a second plate part having a trailing edge with a length, the leading edge is oriented in the direction of rotation and the trailing edge is oriented in an opposite direction. The propeller has at least one first opening between the leading edge and a neighboring trailing edge, said first opening(s) having at least one height h1, determined parallel to the longitudinal axis of the rotary shaft and between the leading edge and the neighboring trailing edge.

### TECHNICAL FIELD

The present invention relates to a cleaning device and in particular a cleaning device which is suitable for underwater cleaning. The invention also relates to a method for cleaning a surface using the cleaning device.

### BACKGROUND ART

In order to obtain a high cleaning quality of a surface underwater or near a water surface it is desirable to use a high pressure washer (HPW). A pump compresses water to a high pressure and releases the water pressure through a small nozzle to create a high velocity water jet. If large surfaces are to be cleaned, a cleaning head with a spray nozzle on a rotating arm is the most efficient. A device like that is often denoted a patio cleaner and is used for cleaning patios and pavements. Such prior art cleaning devices work very efficiently when cleaning upwards facing surfaces that are horizontal or near horizontal. However, where the surface to be cleaned is not upwards facing horizontal or near horizontal surfaces it has been found that such cleaning device will not work properly. This is for example the case where the surface or surfaces to be cleaned involve the sides of a swimming pool and the underside of a boat. When using the prior art cleaning device for cleaning a surface, the force towards the surface from the water jet acts on the surface when the water hits the surface to generate a reacting force which is acting to push the cleaning head away from the surface. Where the surface is not upwards facing horizontal or near horizontal the prior art cleaning device is very difficult or even impossible to hold in the optimal position by a user and accordingly the cleaning will be rather poor.

Another application of cleaning devices of this type is within fish farming in the ocean. Here the fish are kept in a huge net, which is held up by air filled floats. These floats need frequent cleaning for the health and quality of the fish. The floats have a circular cross section, and when they are semi submerged in the water, the submerged surfaces are difficult to clean using prior art cleaning devices.

EP1216761 discloses a device for hydrodynamic cleaning of surfaces. The device comprises a set of injector nozzles placed parallel to tangent to the rotation direction. It further comprises another set of injectors in order to perform the cleaning, and vanes are placed in the periphery of the rotating rotor in order to establish a negative pressure.

### DISCLOSURE OF INVENTION

It is an object of the present invention to provide a cleaning device suitable for cleaning an underwater surface, which cleaning device has a high cleaning effect also when used for cleaning surfaces which are non-horizontal or not upwards facing. It is a further object to provide a cleaning device which can be produced at relatively low cost and which is relatively simple to use.

This and other objects have been solved by the invention as defined in the claims and described herein below.

It has been found that the invention and embodiments thereof have a number of additional advantages which will be clear to the skilled person from the following description.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features.

Reference made to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the skilled person will understand that particular features, structures, or characteristics may be combined in any suitable manner within the scope of the invention as defined by the claims.

The term “substantially” should herein be taken to mean that ordinary product variances and tolerances are comprised.

According to the invention it has been found that by providing the vanes of the propeller with the improved shape as defined in the claims it is possible to keep the cleaning device in a desired position irrespectively of the orientation of the surface under cleaning. Simultaneously the handling of the cleaning device requires very little effort as the force provided by the improved vanes at least partly equalizes the force that arises when the jet force from the water from the nozzles hits the surface to be cleaned. Further the debris can be removed without any substantial risk of clogging the cleaning device.

The cleaning device of the invention comprises a cleaning nozzle unit comprising at least one nozzle. Advantageously the cleaning device has several nozzles preferably arranged with a rotational symmetry of at least two fold. The nozzle(s) can be any kind of nozzle(s) suitable for high water pressure applications. In the following where the cleaning device is described with one nozzle it should be interpreted to include a plurality of nozzles and visa verse unless otherwise specified.

The nozzle comprises at least one exit channel with a nozzle opening. The cleaning nozzle unit is mounted on a rotary shaft. The rotary shaft has a longitudinal axis and a direction of rotation. The cleaning device further comprises a propeller mounted on the rotary shaft.

In use the cleaning nozzle unit and the propeller rotate about the rotary shaft. This rotation may in principle be provided by any means, however, the rotation of the cleaning nozzle unit and the propeller is advantageously provided by ejecting high pressure water through the nozzle i.e. by jetting force. The rotary shaft advantageously comprises at least one swivel ensuring rotation of the cleaning nozzle unit and the propeller without any substantial friction. The cleaning nozzle unit and the propeller are advantageously mounted to the same swivel.

The propeller comprises at least one plate shaped vane, each vane comprises a first plate part comprising a leading edge with a leading edge length and a second plate part comprising a trailing edge with a trailing edge length. The leading edge is oriented in the direction of rotation and the trailing edge is oriented in a direction opposite the rotation direction.

The plate shaped vane advantageously extends outwards from the rotary shaft and the leading edge and the trailing edge advantageously also extend outwards from a position closer to the rotary shaft to a position more remote to the rotary shaft. The leading edge and the trailing edge may independently from each other be radially extending or non-radially extending.

The at least one vane has a front surface facing a front plane and an opposite rear surface. The front plane is defined as a plane comprising the at least one nozzle opening and being perpendicular to the longitudinal axis of the rotary shaft. The front surface of the propeller is defined as the surface of the propeller facing the front plane. The rear side of the propeller is defined as the surface of the propeller turned away from the front plane.

The propeller comprises at least one first opening between the leading edge and a neighboring trailing edge. Advantageously the propeller has N first openings wherein N is the number of vanes.

Each first opening has at least one height h1, determined parallel to the longitudinal axis of the rotary shaft and between the leading edge and the neighboring trailing edge, the height h1 comprises a maximum height h(max). The height h1 may be equal along the lengths of the leading edge and the trailing edge in which situation the first opening has only one height h1, or preferably the height h1 varies along the lengths of the leading edge and the trailing edge in which situation the first opening has plurality of heights h1.

The rotary shaft or a part of the rotary shaft with the propeller and cleaning nozzle unit and an optional housing preferably provides a cleaning head of the cleaning device. Advantageously the cleaning device further comprises a handle connected to the rotary shaft for handling the cleaning head and one or more pipes for guiding water from a water supply e.g. comprising a compressor and to the cleaning nozzle unit.

Advantageously a compressor comprising a pump compresses water to a high pressure level such as up to 350 bars or even higher and the water is led to the nozzle unit advantageously through the one or more pipes which may be arranged along or integrated into the handle and optionally the rotary shaft of the cleaning device. The water could alternatively be directed through a separate pipe. The water leaves the cleaning device through the opening(s) of the nozzles. The jet direction of the water is controlled by the exit channel adjacent to the nozzle opening. The cleaning nozzle unit comprises advantageously two nozzles mounted on respective arms and in fluid communication with the shaft. In an embodiment the cleaning nozzle unit comprises two nozzles mounted on respective arms extending radially from the rotary shaft and in opposite directions. The propeller is attached to the rotary shaft and rotates advantageously synchronously with the nozzle unit. Advantageously the rotation is caused by the jet stream from the nozzles. However, the rotation could also be achieved by incorporating a motor in the device. The propeller is advantageously shaped as a circular plate-shaped unit comprising the vanes. Preferably the openings of the nozzle(s) turn in a predefined direction i.e. towards or away from the surface to be cleaned.

The terms “jet stream” or “water jet stream” mean the stream of water ejected from the nozzle. The term “jet direction” is the direction of the jet stream as it leaves the nozzle. The term “jet force” means the force from jet stream acting towards a surface under cleaning. The term “water pressure” means the pressure of the water as it leaves the nozzle.

In use the cleaning device of the invention is arranged such that water jet stream from the nozzles jetts towards the surface to be cleaned. Due to the water jet stream from the nozzles, the debris attached to or adhered to the surface can be released and due to the shape of the propeller such released debris flow with a water stream into the first openings formed between the leading edge of one vane and the trailing edge of the neighboring vane. The first openings are oriented in a direction substantially parallel to the longitudinal axis of the rotary shaft. The trailing edge of the neighboring vane of a vane in question is the trailing edge closer to the leading edge of the vane in question. The trailing edge and the leading edge may belong to the same vane where there is only one vane or the trailing edge may belong to another vane different from the vane comprising the leading edge in question where the propeller comprises a plurality of vanes.

In use the jet stream towards the surface under cleaning results in a first force. This first force acts to push the cleaning device away from the surface under cleaning. Due to the rotation of the propeller the debris and water are pressed into the first opening(s) and a second force is generated. The second force advantageously has a direction substantially opposite the direction of the first force. The second force provided by the rotating propeller depends among other things on the size of the first opening(s).The larger the first opening(s), the larger the second force will be. For that reason the height h1 is advantageously selected larger for a device using a larger water pressure P1—compared to a device using a lower water pressure P0. The water pressure can in principle be as high as desired. For most applications of the cleaning device of the invention a water pressure up to about 350 bars is sufficient. The water pressure will advantageously be from about 80 bars to about 300 bars, such as from about 150 bars to about 240 bars.

Hereby the cleaning device can be constructed such that the two forces—the first force and the second force to a large degree neutralize each other e.g. at least 80%, or even at least about 90% of the larger of the first or the second force will advantageously be neutralized. This makes the device even easier to handle and the cleaning device can be held in a position for effective cleaning in a simple and easy way without the use of excessive manual power. The rotation of the propeller is advantageously effected by rotation of the rotary shaft to which the propeller is attached e.g. by rotation of a swivel of the rotatory shaft where advantageously both the propeller and the nozzle unit are mounted to the swivel. The rotation axis of the propeller is thereby coincident with the longitudinal axis of the rotary shaft.

In an embodiment one of the first part and the second part of the at least one vane is substantially planar and parallel with a plane perpendicular to the longitudinal axis of the rotary shaft.

In an embodiment the vanes comprise a first plate part and a second plate part which are substantially planar and angled in relation to each other whereby the first opening is provided.

In an embodiment the at least one of the first plate part and the second plate part is curved such as with a curvature that bends towards the other one of the first plate part and the second plate part of a vane.

In an embodiment the first plate part is bent downwards i.e. towards the front plane along a bending line connecting the first plate part and the second plate part of the vane. Thereby the stream of debris and water flow through the first opening and further along the rear surface of the first plate part. The debris further flow along the second plate part along the rear surface and are forced away from the device by centrifugal force provided by the rotation of the propeller. The second plate part is advantageously positioned with its rear surface substantially perpendicular to the longitudinal axis of the rotary shaft. In this embodiment the second plate part is advantageously planar and the first plate part is advantageously planar or curved with a curvature that bends away from the front plane.

In an embodiment the second plate part is bent upwards i.e. away from the front plane along a bending line connecting the first plate part and the second plate part of the vane. The first openings provide a fluid communication between the front surface of the propeller and the rear surface of the propeller. The rear surface is the surface that turns away from the surface to be cleaned. In this embodiment the first plate part is advantageously planar and the second plate part is advantageously planar or curved with a curvature that bends towards the front plane.

The propeller comprising the vane(s) with first and the second plate part is advantageously formed from a substantially circular sheet of a desired material.

The cleaning device can in principle be of any material or combinations of materials which are sufficient strong to withstand the forces it will be subjected to. Suitable materials comprise any metals and/or thermoset polymers such as steel and fiber reinforced polymer. In particular the propeller will be subjected to high loads and wear. In an embodiment the propeller is of stainless steel, such as electro plated steel or galvanized steel. In an embodiment the propeller is of glass fiber armed polymer.

Irrespectively of how the first opening is provided, the angles of attack of the propeller vanes are advantageously adjusted to be at least about 10 degrees, such as from about 25 degrees to about 50 degrees, such as from about 30 degrees to about 40 degrees, advantageously about 36 degrees which has been found to be suitable for most purposes. The angle of attack of a vane is the average angle of the leading edge relative to a plane perpendicular to the longitudinal axis of the rotary shaft. In an embodiment where the cleaning device is to be used with an extremely high water pressure, such as 200-300 bars or even higher, the first opening is advantageously increased relative to the above mentioned embodiments and the angle between the first and the second part is increased accordingly.

The cleaning device may work with only one single vane but in order to improve the effect of the cleaning device it is an advantageous that the device comprises several vanes whereby several first openings are provided. Advantageously 4-6 vanes are chosen.

In an embodiment the propeller comprises at least two vanes, a first vane and a second vane. Preferably each vane comprises the first plate part comprising the leading edge oriented in the direction of rotation and the second plate part comprising the trailing edge oriented in the direction opposite the rotation direction. The first openings are arranged between the leading edges of the vanes and the trailing edge of their respective neighboring vanes.

By having at least two or more vanes the effect of the cleaning device may be increased because the number of first openings usually will be equivalent to the number of vanes. Thereby the cleaning device will be easier to handle which naturally results in an increased efficiency.

The nozzle unit comprises at least one nozzle and advantageously two nozzles placed opposite each other. Advantageously each nozzle is mounted on an arm in fluid communication with a pipe integrated in the rotary shaft. The nozzles are in an embodiment arranged such that a center axis of each nozzle is parallel to the axis of rotation of the cleaning device i.e. the center axis of the rotary shaft.

Advantageously the nozzles are arranges such that the water jet streams ejected from the nozzles result in a rotation of the rotary shaft and thereby rotation of the cleaning nozzle unit and the propeller.

In an embodiment the nozzle is positioned such that it moves along a nozzle rotation circle when it is rotates about the rotary shaft. The nozzle has a jet direction which may be determined as the center axis of the exit channel of the nozzle adjacent to the nozzle opening. The jet direction is parallel to a tangent plane to the nozzle rotation circle, preferably with an angle to the nozzle rotation circle of from about 1 degree to about 85 degrees, such as from about 5 degrees to about 45 degrees. Thereby a suitable rotation of the rotary shaft can be achieved by the jet force.

In an embodiment the jet direction is parallel to a tangent plane to the nozzle rotation circle, preferably with an angle to the nozzle rotation circle of from about 25 to about 50 degrees, advantageously from about 30 to about 45 degrees, e.g. about 40 degrees. The angle of the jet directions of the nozzles has an impact on the rotation speed.

In an embodiment when the jets from the nozzles force the rotary shaft to rotate, the propeller also rotates creating a thrust forcing the cleaning head towards the surface to be cleaned. The propeller and the nozzle unit advantageously rotate with equal rounds per minute by being connected to each other e.g. by being mounted to the same swivel. The rotation speed is advantageously between from about 100 to about 400 rpm depending on whether the device is used submerged in water or it is used above water. Advantageously the rotation speed can be varied by the user of the cleaning device.

In an embodiment the propeller is positioned behind the nozzle openings to have a relatively short distance to the front plane comprising the at least one nozzle opening, such as a minimum distance of about 5 cm or less, such as of about 2 cm or less. The phrase “the propeller is positioned behind the nozzle openings” means that the propeller is positioned such that a jet stream from the nozzle streams away from the propeller.

Thereby the rotation of the propeller is not counteracted by the jet stream as the jet stream does not hit the propeller. The nozzle openings are turned in a preselected direction, such that the jet stream preferably reaches a planar surface to be cleaned with a preselected angle.

By “neighboring trailing edge” is meant the trailing edge placed closest to a leading edge determined in the direction of rotation. When the cleaning device comprises one vane, the neighboring trailing edge belongs to the same vane as the leading edge in question. When the cleaning device comprises two or more vanes, the neighboring trailing edge belongs to another vane than that comprising the leading edge in question.

In an embodiment the height h1 between the leading edge and the neighboring trailing edge varies in dependence of the distance to the longitudinal axis of the rotary shaft. The term “height h1” advantageously mean “height h1 as a function the distance to the longitudinal axis of the rotary shaft” Advantageously the height h1 between the leading edge and the neighboring trailing edge increases with the distance to the longitudinal axis of the rotary shaft. In a preferred embodiment the first opening has an outermost periphery comprising the height h(max).

Thereby the area of the opening is increased in radial direction making the opening in the periphery larger compared to the opening closer to the rotating shaft. The highest value of h1 is h(max) and h(max) is preferably found in the periphery of the first opening. The height of the first opening measured closest to the rotary shaft is from about 0 to about h(max), preferably up to about 0.2 times h(max). The height of the first opening measured in the periphery of the first opening is advantageously from about 0.5 times h(max) to about h(max). h(max) is preferably from about 0.1 to about 0.8 times the leading edge length, such as from about 0.5 to about 0.7 times the leading edge length.

However, the height h1 of the first opening could alternatively be uniform between and along the lengths of the leading and the trailing edge.

The propeller and the cleaning nozzle unit and an optional housing as well as the part of the rotary shaft preferably provide the cleaning head of the cleaning device.

The cleaning head is advantageously constructed to have a rear opening allowing water carrying released debris to pass through and away from the person handling the device. The construction is simple and substantially all of the water led to the cleaning device is used for the main purpose, namely cleaning the surface in question.

As indicated above the cleaning device advantageously comprises a housing containing at least a part of the propeller, the rotating shaft and/or the nozzle unit. The housing serves to protect the propeller and optionally the cleaning nozzle unit. Further the housing is advantageously constructed to prevent the debris leaving the device from hitting the person using the cleaning device.

The housing preferably comprises a substantially cylinder-shaped plate part encircling the propeller and the nozzle unit. A longitudinal axis of the cylinder-shaped plate part is coaxial with the rotating shaft.

In an embodiment the cylinder-shaped plate part comprises a wall opening through which the debris released from the surface can escape. The wall opening through which the debris may escape is advantageously placed opposite to the handle or any other holding element such that the person handling the device will not be exposed to escaping debris.

In an embodiment the housing comprises a first protection plate covering the front surface of the vane(s).The protection plate comprises openings for allowing fluid communication into the housing and through the first opening(s) of the cleaning device.

This is especially an advantageous when the device is used for cleaning a pontoon surrounding a fish farming. The protection plate protects the net attached to the pontoon in such a way that it is not cut into pieces by the rotating elements of the cleaning device. Further the plate also protects fish and other animals in the water against the rotating elements of the cleaning device. Also the protection plate serves to protect the user against being injured by the propeller.

In an embodiment the housing comprises a rear plate covering the rear surface of the vane(s). The rear plate advantageously comprises openings for allowing water carrying debris escaping from the housing. Advantageous the housing is constructed such that water carrying debris can escape both through a wall opening through the cylinder-shaped plate part and through openings in the rear plate.

In an embodiment the propeller comprises one or more connection bands, each arranged to connect a radially outer part of a vane with a radially outer part of its neighboring vane. The radially outer parts connected with the connection band(s) are either radially outermost parts of first parts of the respective vanes or radially outermost parts of second parts of the respective vanes. The connection band or bands may in principle have any shape provided that they provide a stable connection between first plate parts or between second plate parts.

The connection bands serve to stabilize the propeller, in particular where the propeller comprises more than one vane in which situation the connecting bands connect one vane with its neighboring vane. The connection band ensures that the leading edge is stabilized.

The connection bands further serve to stabilize the propeller during an optional heat treatment e.g. where the propeller is heated during production e.g. during a surface treatment. The connection bands ensure that the propeller is not becoming skewed.

Advantageously the first plate and the second plate are connected along a bending line.

Where the first opening is provided by bending the first plate towards the front plane e.g. along the bending line which is preferably substantially radial relative to the rotary shaft, the connection band ensures stability of this bending line as well of the second plate belonging to the neighboring vane. Thereby the leading edge will also be stabilized.

Where the first opening is provided by bending the second plate part away from the front plane e.g. along the bending line which advantageously is substantially radial relative to the rotary shaft, the connection band ensures stability of this bending line as well of the leading edge.

In an embodiment the propeller comprises one vane and the opening is provided by bending the first plate part towards the front plane, the connecting band connects the second plate part of the vane with itself. Thereby the vane is stabilized and risk of undesired vibrations of the plate is minimized.

When the propeller comprises one vane and the opening is provided by bending the second plate part away from the front plane, the connecting band connects the first plate part of the vane with itself whereby the leading edge is directly stabilized.

For optimal stability the connection band(s) is/are arc shaped. Advantageously the connection bands comprise each a radially outermost edge which forms part of an outer periphery of the propeller.

In an embodiment the radially outer parts connected with the connection band(s) comprise radially outermost edges which together with the radially outermost edge(s) of the connection bands form the outer periphery of the propeller.

In an embodiment the minimum distance between at least one of the leading edges and the nozzle opening(s) measured parallel to a plane perpendicular to the longitudinal axis of the rotary shaft is smaller than the minimum distance between the trailing edge and the nozzle opening(s) measured parallel to a plane perpendicular to the longitudinal axis of the rotary shaft.

Thereby the main part of released debris will flow directly into the first opening(s). The minimum distance between a leading edge and the nearest nozzle opening is advantageously quite small, such as up to about the leading edge length, such as from about 30% to about 80% of the leading edge length e.g. from 2 to 6 cm. Thereby the second force provided by the rotating propeller may be optimized.

In a further embodiment of the invention the nozzle unit comprises two separate nozzles placed opposite each other in a radial distance from a center line of the rotary shaft, the high pressurized water is advantageously led through the shaft through radially pointing pipes to the nozzle placed at the end of each pipe.

In an embodiment the nozzle unit comprises at least two separate nozzles arranged in a radial distance from the longitudinal axis of the rotary shaft.

Advantageously the two or more nozzles are arranged with substantially equal distance to the longitudinal axis of the rotary shaft. By having two nozzles placed in equal distance from the longitudinal axis of the rotary shaft, the rotation of the propeller will be further stabilized. Where there are more than two nozzles they are preferably all mounted with equal distance to the longitudinal axis of the rotary shaft. The nozzles are preferably arranged symmetrically relative to a symmetry plane parallel to the longitudinal axis of the rotary shaft. In an embodiment where the cleaning device comprises an equal number of nozzles of 4 or more these nozzles are advantageously pairwise mounted opposite to each other and with pairwise equal distance to the longitudinal axis of the rotary shaft.

The water may be delivered to the nozzles by any pipe construction suitable. In an embodiment the cleaning device comprises at least one shaft pipe section extending through the rotary shaft and one or more nozzle pipe sections connecting the shaft pipe section to the nozzles for supplying of water.

In an embodiment the first plate and the second plate of the vane are angled with an angle V in relation to each other. The angle V is preferably from about 100 degrees to about 170 degrees, such as from about 110 degrees to about 160 degrees. Advantageously the angle V is selected in dependence of a selected power of the device determined as the water pressure P of water ejected via the nozzle(s), such that the larger the water pressure P, the larger the angle V.

In an embodiment the one or more nozzles are located within the outer periphery of the propeller. By placing the nozzles within the outer periphery of the propeller it is possible to obtain a very compact cleaning device.

In an embodiment which may also provide a cleaning device which may be constructed to be very compact the one or more nozzles are integrated with the propeller. By having the nozzles integrated with the propeller a compact cleaning device may be obtained, and, moreover, the propeller may serve to protect the nozzles toward damage. By using the term “integrated” is meant that the nozzles are placed adjacent to the propeller, i.e. with a distance from 0 to about 3 cm between the propeller and the cleaning nozzle unit. Optionally the nozzles and/or the cleaning nozzle unit are attached to the propeller. The nozzles may also pass through openings in the propeller.

When the pressure from the water jet is high, the area of the first opening is advantageously increased. This can be done in a simple manner by increasing the angle V between the first plate part and the second plate part whereby the heights are increased. For example where an optimal angle V of about 144 is found at a water pressure of about 200 bars, the optimal angle V may e.g. be about 146 at a water pressure of about 220 bars.

In an embodiment at least one of the trailing edge and the leading edge of the vane is substantially straight. Thereby the trailing edge may serve as a cutting means adapted to cutting sea weed and/or debris to pieces that have been removed from the surface under cleaning or even prior to its removal of the surface. Preferably at least one of the trailing edge and the leading edge of the vane is substantially radially directed from the longitudinally axis of the rotary shaft.

In an embodiment the leading edge(s) comprises a cutting edge adapted to cutting sea weed and/or debris to pieces, preferably the leading edge(s) has a material thickness of 3 mm or less, more preferably the leading edge(s) is tapered thereby providing an effective cutting edge.

The cleaning device according to the invention may comprise a rear protective plate and a front protective plate. Both the rear protective plate ant front protective plate comprises openings which will allow water to flow through the plates, but still be able to prevent rope and similar items to enter the cleaning device and block the propeller. The front protective front plate in particular, which will be facing the surface to be cleaned should comprise openings with a size and shape which will allow the water jets from the nozzles to reach surface to be cleaned.

The invention also relates to a method for cleaning a surface of an item using the cleaning device as described above.

The method comprises arranging the cleaning device with its vane front surface facing the surface to be cleaned, jetting water via the nozzle(s) towards the surface while simultaneously rotating the propeller such that debris attached to the surface are released, and the released debris are led through the first opening(s) placed between the leading edge of one vane and the trailing edge of the neighboring vane, by a water stream generated by the rotation of the propeller.

Advantageously the jetting water is led via the nozzle(s) towards the surface and thereby results in the first force and the cleaning device is held such that the second force acting against the first force is achieved wherein the second force is provided by the rotation of the propeller. The function of the second force is described above.

Advantageously the edge comprises a cutting edge as described above and the method comprises cutting debris and/or sea weed to pieces.

The method can in principle be used on any surface to be cleaned, but it is preferred that the surfaces to be cleaned is a surface under or close to water such as surfaces of ships, pontoons for net belonging to fish farming in the ocean.

In an embodiment of the invention debris attached to the surface are released by jetting the water towards the surface of the item and the debris are lead through the first openings and leave the device.

The high pressure from the water leaving the nozzle unit ensures that major parts or even all of the debris attached to the surface to be cleaned are released. The debris are then sucked into the first openings and leave the cleaning device by means of the centrifugal force provided by the rotation of the propeller.

As indicated above the cleaning device advantageously comprises a handle. Advantageously the handle is placed at the rear side of the propeller.

Depending on the surface to be cleaned the handle may be angled in different ways. If the surface is a plane horizontal surface, the handle is most likely a straight rod angled 20-40 degrees in relation to the longitudinal axis of the rotary shaft. If the surface to be cleaned is curved and perhaps placed partly or fully underwater, the handle may be a bent rod or a curved rod or any other shaped rod which for suitable handling of the cleaning device for cleaning of surfaces. The handle is advantageously a hollow shaft comprising a pipe structure through which the water may be injected for being guided to the nozzles. The hollow handle is advantageously is fluid communication with the rotating shaft and the nozzle unit.

In an embodiment the rotary shaft is connected to a swivel. Thereby the rotary shaft is able to rotate with very little friction. Advantageously the pressurized water is led through the swivel through the shaft and further to the nozzle unit.

In an embodiment the periphery edge of the propeller is a circular edge.

All features of the inventions including ranges and preferred ranges can be combined in various ways within the scope of the invention, unless there are specific reasons for not to combine such features.

### BRIEF DESCRIPTION OF DRAWINGS

The invention is explained in further below with reference to the drawings in which

FIG. 1 shows a perspective view of a first embodiment of a cleaning device according to the invention where the cleaning device comprises a housing.

FIG. 2 shows a detailed perspective view of the first embodiment of the cleaning device shown in FIG. 1 without the housing.

FIG. 3 shows a perspective view of a second embodiment of a cleaning device according to the invention where the cleaning device comprises several vanes and a housing.

FIG. 4 shows a perspective view of a third embodiment of a cleaning device according to the invention where the cleaning device comprising one vane.

FIG. 5 shows a perspective view of a fourth embodiment of a cleaning device according to the invention where the cleaning device comprising one vane.

FIG. 6A shows a perspective view of a fifth embodiment of a cleaning device according to the invention where the cleaning device comprises several vanes.

The figures are schematic and may be simplified for clarity. Throughout, the same reference numerals are used for identical or corresponding parts.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

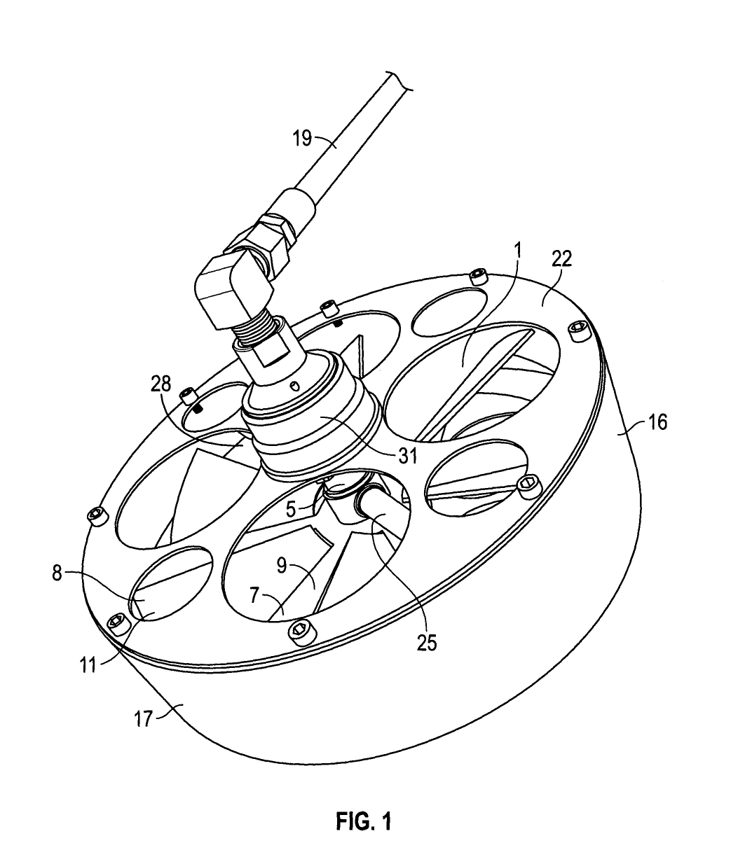

FIG. 1 shows a perspective view of a first embodiment of a cleaning device 1 according to the invention. The cleaning device 1 comprises a housing 16. The housing 16 has a cylinder-shaped metal plate part 17 enclosing the propeller 7 of the cleaning device 1. The cleaning device 1 comprises the propeller 7 mounted to a rotary shaft 5. The rotary shaft 5 has a longitudinal axis and the housing 16 has a longitudinal axis concentrically with the longitudinal axis of the rotary shaft 5. The propeller 7 has a periphery which is arranged to have a small distance to an inner surface of the housing 16 such that when the propeller 7 rotates it does not touch the inner surface of the housing 16. The cleaning device 1 comprises a cleaning nozzle unit 3 comprising radially extending arms 25 and nozzles 6 mounted to the radially extending arms 25. The rotary shaft 5 is connected to a swivel 31 and a handle 19 is further connected to the swivel 31. High pressurized water is injected through the hollow handle 19 into the shaft 5 from where it is passed through pipes integrated in the radially extending arms 25 and further to the nozzles 6. The housing 16 comprises a rear protection plate 22.

The propeller comprises several vanes 8 formed from a circular plate. A rear surface 28 of the propeller 7 is facing away from a front plane perpendicular to the rotary shaft 5 and comprising the nozzle openings.

Each vane 8 comprises a first plate part 9 and a second plate part 11. The first plate part 9 extends substantially even and flat in radial direction and the rear surface of the first plate part 9 forms a substantially 90° angle in relation to the longitudinal axis of the rotating shaft 5.

The second plate part 11 is angled V in relation to the first plate part 9. The angle is as described above.

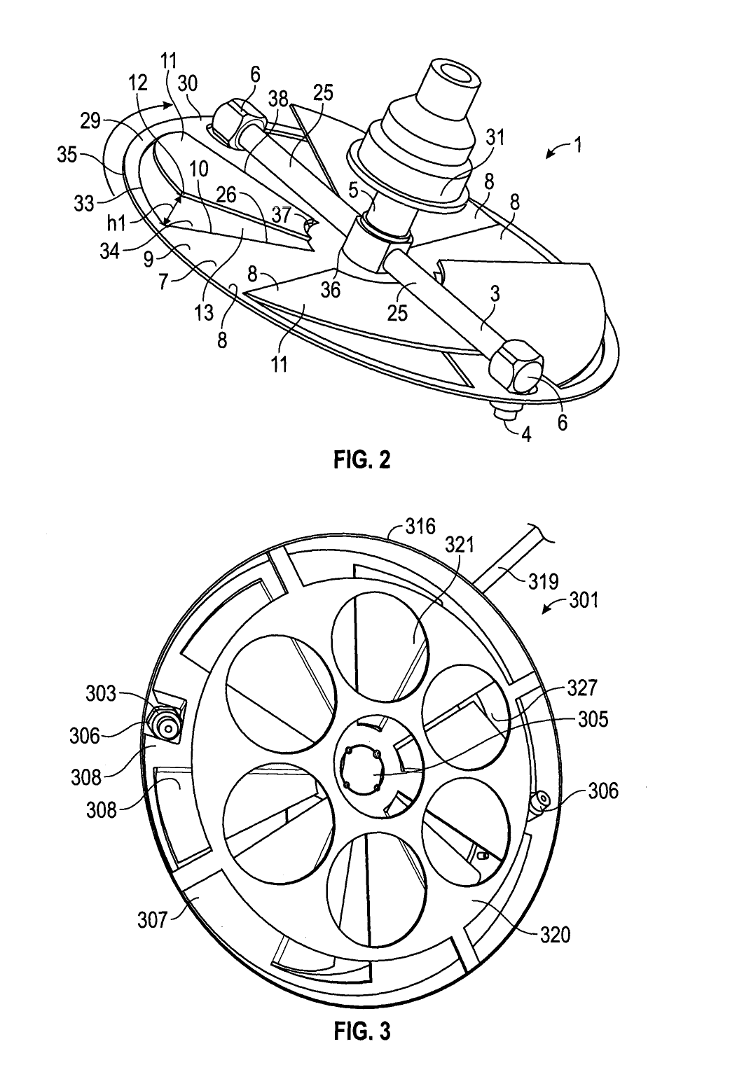

In FIG. 2 it can be seen that the vanes 8 are plate-shaped and that the propeller 7 comprises 4 vanes. The second plate part 11 is bent in a direction away from the front plane comprising the nozzle openings 4 of the nozzle unit 3. The nozzle unit 3 comprises two nozzles 6, each nozzle 6 is positioned closely to the periphery of the propeller 7 and with the nozzle openings 4 pointing in a direction towards a surface to be cleaned by the cleaning device 1. Each nozzle 6 is adapted to eject high pressurized water out through the nozzle openings 4 and the nozzles 6 receive the water via the pipes integrated into the arms 25 as explained above.

When the nozzles 6 rotate due to the jetting force from the pressurized water, the propeller 7 also rotates as the propeller 7 and the nozzle unit 3 are mounted to the rotatable shaft 5.

The propeller 7 is formed from a circular plate shaped unit. The vanes 8 are provided by cutting out a plate part providing the second plate part 11. This is done by cutting a first curved cutting line 33 near the periphery of the circular plate unit at a short distance from a peripheral edge 35 of the circular plate-shaped unit. The first curved cutting line 33 has a center identical to the center of the circular plate-shaped unit. At this cutting line a circular arc shaped connection band 29 is provided.

The connection band 29 connects a radially outermost part 30 of a first plate part 9 of a vane with a radially outermost part 30 of a first plate part 9 of a neighboring vane.

A second straight cutting line 34 is provided by cutting a straight line from an end of the first cutting line 33 and in radial direction towards the center of the plate-shaped unit. The second cutting line 34 ends at a short distance from the inner edge 36 of the circular plate-shaped unit.

A third curved cutting line 37 having a center identical to the center of the circular plate-shaped unit is provided. The second plate part 11 is bent along a bending line 38 to have the selected angle V to the first plate part 9. Thereby the vane 8 is formed comprising the first plate part 9 which is parallel to the front plane and the second plate part 11 with an angle V to the first plate part 9.

The first plate part 9 comprises a leading edge 10 which follows the second cutting line 34 and therefore extends substantially radial from the rotary shaft 5. The cleaning device 1 rotates with the leading edge 10 of the vane 8 in front such that the leading edge 10 cuts through the water in which the cleaning device is submerged. Between a leading edge 10 of one vane 8 and a trailing edge 12 of a neighboring vane 8 a vertical first opening 13 is provided. The first opening 13 has heights h1 measured in parallel to the rotary shaft 5 along and between the leading edge 10 and the neighboring trailing edge 12.

The height h1 between the leading edge 10 and the neighboring trailing edge 12 varies in dependence of the distance to the longitudinal axis of the rotary shaft 5. The height h1 between the leading edge 10 and the neighboring trailing edge 12 increases with the distance to the longitudinal axis of the rotary shaft 5 and the first opening 13 has an outermost periphery comprising the height h(max).

The distance between the leading edges 10 and the nozzle openings 4 measured parallel to the longitudinal axis of the rotation shaft 5 is smaller than the distance between the trailing edge 12 and the nozzle opening 4 measured parallel to the longitudinal axis of the rotation shaft 5.

Each vane 8 comprises the first plate part 9 comprising the leading edge 10, and the second plate part 11 comprising the trailing edge 12 where the first plate part 9 and the second plate part 11 are connected along the bending line 38. Further the propeller comprises the circular arc shaped connection band 29. In this embodiment the propeller 7 comprises 4 vanes. However, the propeller could also comprise more or less vanes 8. It could comprise just one single vane 8. The leading edge 10 advantageously comprises a sharp cutting edge 26 as described above.

FIG. 3 shows a second embodiment of the cleaning device 301 according to the invention. The cleaning device comprises a housing 316. The difference between the cleaning device 301 of FIG. 3 and the cleaning device 1 of FIG. 1 is that the cleaning device 301 of FIG. 3 comprises 6 vanes and further the cleaning device 301 is seen from its front. The housing 316 comprises a first protection plate 320 covering the front surface of the propeller 327 which ensures that when the device is used for cleaning pontoons of a fishing net placed in an ocean, the fish and the net are not damaged by the rotating propeller. The protection plate 308 comprises openings for allowing fluid communication into the housing and through the first opening(s) of the cleaning device.

The nozzle unit 303 comprises two nozzles 306. Each nozzle 306 is mounted on an arm 35 comprising integrated pipe for guiding water to the nozzles 306. When the jet stream from the nozzles 306 forces the propeller 307 to rotate, the rotation creates a counter force that forces the cleaning head against the surface to be cleaned. The propeller 307 and the nozzle unit 303 rotate with the same rounds per minute. The direction of the water jet stream is angled by angling the longitudinal axis of the nozzles 306. The jet direction is tangentially angled such that the force provided by the jet stream forces the propeller 307 and the nozzles 306 to rotate. Thereby the second force acting in opposite direction relative to the first force is achieved. The first force is the force that occurs as a consequence of the water jet stream hitting the surface to be cleaned. The released debris and water are sucked through the first openings 313 provided in the propeller 307.

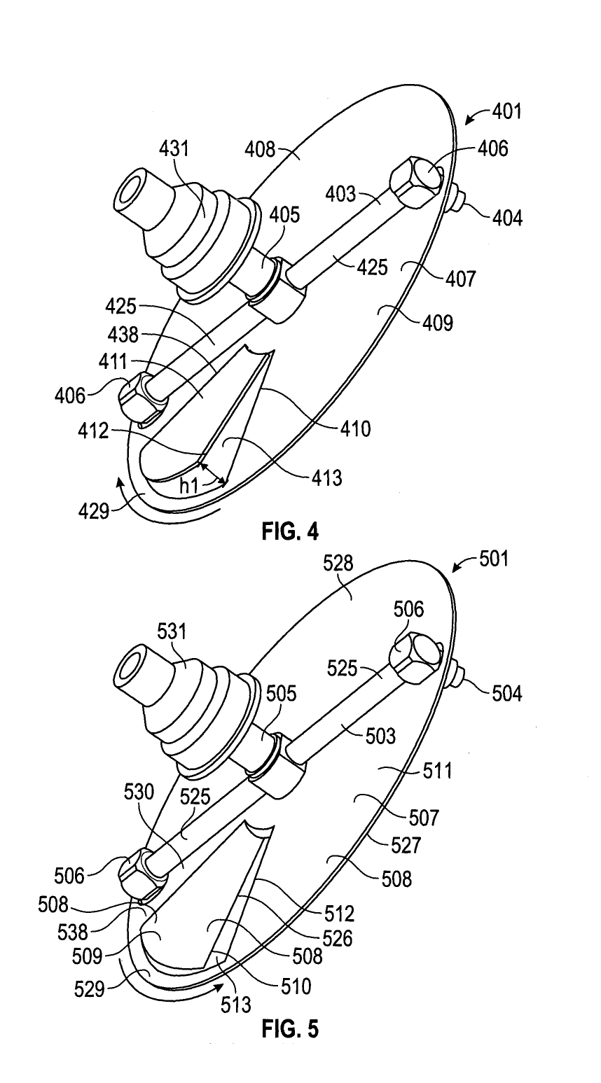

FIG. 4 shows a third embodiment of a cleaning device 401 according to the invention. The cleaning device comprises a propeller 407 and is made in the same way as the embodiment shown in FIG. 2. However, it comprises only 1 vane 408. The first opening 413 is therefore provided between the leading edge 410 and the trailing edge 412 of the same vane 408. As a consequence there is only one first opening 413 provided and only one first plate part 409 and one second plate part 411 interconnected via bending line 438.

The bold arrow shows the rotation direction of the device 401 during operation. The cleaning nozzle unit 403 is made in the same way in the embodiments of FIG. 2 and FIG. 3.

The Propeller 407 is mounted to the rotary shaft 405 which comprises a swivel 431 for low friction rotation. The nozzles 406 comprise nozzle openings 404. The propeller 407 comprises an arc shaped connection band 29 connecting a radially outermost part of a first plate part 9 with itself where the connection band 29 extend from adjacent the bending line to adjacent the leading edge 410.

It should be noticed that the nozzle unit 403 could comprise several nozzles, thereby providing more jet streams than two.

FIG. 5 shows a fourth embodiment of a cleaning device 501 according to the invention. The cleaning device comprises a propeller 507, the propeller 507 comprises one single vane 508. The difference between the embodiment shown in FIG. 4 and this embodiment is the way the vane 508 is provided and constructed. The nozzle unit 503 is made in the same way as in FIG. 4 and the propeller 507 rotates due to the same mechanism as explained above.

The radially extending arms 525 are arranged above the rear surface 528 of the propeller 507. The rotation direction is indicated by a bolt arrow. The first plate part 509 is bent downwards the front plane i.e. in a direction closer to the nozzle openings. The first plate part 509 is made in the same way as is the case with the second plate part 511 in the above examples by cutting the three cutting lines as explained. In this embodiment it is the first plate part 509 that is bent in a certain angle V in relation to the second plate part 511 which is substantially parallel to the front plane. The leading edge 510 is in this way arranged closer to the nozzle opening 504 than the lower surface 527 of the second plate part 511. An arc shaped connection band 529 connects the trailing edge 512 with the bending line 538 between the first plate part 509 and the second plate part thereby stabilizing the construction. The released debris leave through the first opening 513 provided between the leading edge 510 and the trailing edge 512.

The height h1 between the leading edge 510 and the trailing edge 512 varies in dependence of the distance to the longitudinal axis of the rotary shaft 505. The height h1 between the leading edge 510 and the neighboring trailing edge 512 increases with the distance to the longitudinal axis of the rotary shaft 505 and the first opening 513 has an outermost periphery comprising the height h(max).

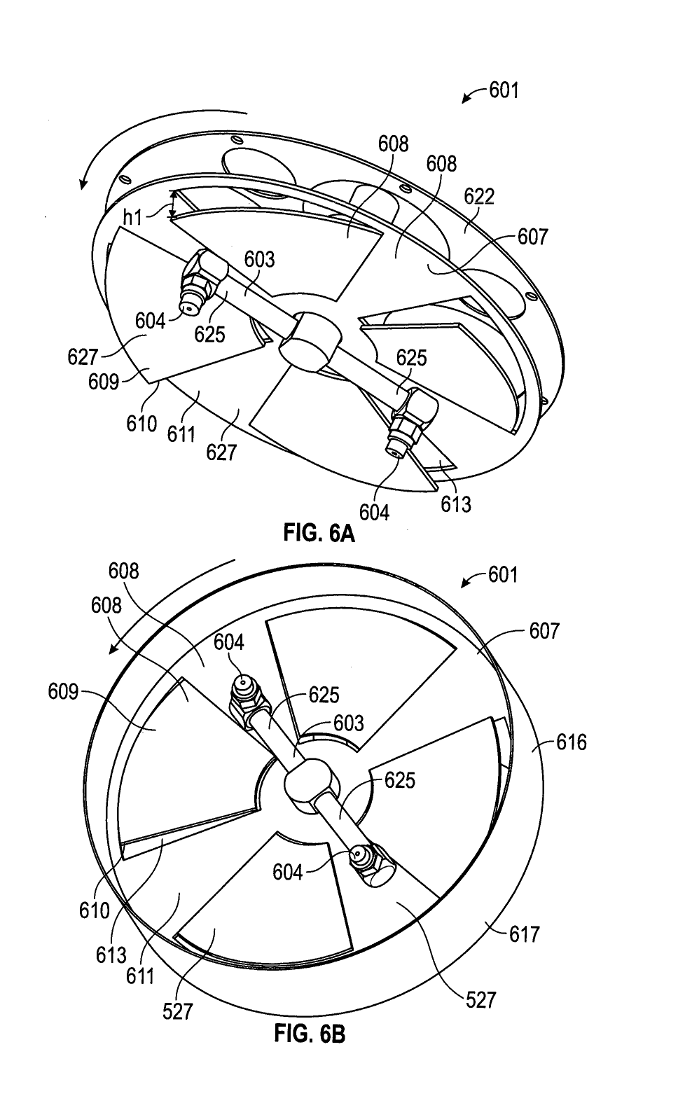

FIG. 6A shows a fifth embodiment of a cleaning device 601 according to the invention. The cleaning device is in principal made in the same way as the one shown in FIG. 5 but with a plurality of vanes 608. The first plate part 609 is placed with the leading edge 610 closer to the nozzle openings 604 than the front surface 627 of the second plate part 611. However, the propeller 607 comprises four vanes 608 and the nozzle unit 603 is arranged fully in front of the front surface 627 of the propeller 607.

Due to the four vanes 608 of the propeller 607, four first openings 613 are provided through which the released debris can pass to leave the device 601. A rear protection plate 622 is placed at a distance from the rear surface 628 of the propeller in order to protect the user. The rear protection plate 622 may advantageously have openings which may guide the debris in a predefined direction.

FIG. 6B shows a variation of the cleaning device shown in FIG. 6A where the cleaning device 601 comprises housing 616 constructed as a cylinder. The walls of the cylinder enclose the periphery of the propeller 607. An opening may be provided in the wall 617 in order to lead the removed debris in a certain direction. The opening is advantageously placed opposite a handle for handling the apparatus.

Some preferred embodiments have been shown in the foregoing, but it should be stressed that the invention is not limited to these, but may be embodied in other ways within the subject-matter defined in the following claims.

What is claimed is:

1-20. (canceled)

21. A cleaning device comprising a cleaning nozzle unit comprising at least one nozzle comprising at least one exit channel with a nozzle opening, said cleaning nozzle unit is mounted on a rotary shaft , said rotary shaft has a longitudinal axis and a direction of rotation, the cleaning device further comprises a propeller mounted on the rotary shaft,
the propeller comprises at least one plate shaped vane, each vane comprises a first plate part comprising a leading edge with a leading edge length and a second plate part comprising a trailing edge with a trailing edge length, the leading edge is oriented in the direction of rotation and the trailing edge is oriented in a direction opposite the rotation direction,
the at least one vane has a front surface facing a front plane comprising the at least one nozzle opening and being perpendicular to the longitudinal axis of the rotary shaft and an opposite rear surface,
the propeller further comprises at least one first opening between the leading edge and a neighboring trailing edge, said first opening(s) having at least one height h1, determined parallel to the longitudinal axis of the rotary shaft and between the leading edge and the neighboring trailing edge, said height h1 comprises a maximum height h(max).

22. The cleaning device according to claim 21, wherein the propeller comprises at least two vanes, a first vane and a second vane, each vane comprising the first plate part comprising the leading edge oriented in the direction of rotation and the second plate part comprising the trailing edge oriented in the direction opposite the rotation direction, said first openings are positioned between the leading edges of the vanes and the trailing edge of their respective neighboring vanes.

23. The cleaning device according to claim 21, wherein one of the first part and the second part of the at least one vane is substantially planar and parallel with a plane perpendicular to the longitudinal axis of the rotary shaft.

24. The cleaning device according to claim 21, wherein the propeller comprises at least one connection band(s) arranged to connect a radially outer part of a vane with a radially outer part of a neighboring vane wherein the radially outer parts connected with the connection band(s) are either radially outermost parts of first parts of the respective vanes or radially outermost parts of second parts of the respective vanes or, preferably the connection band(s) is arc shaped, the connection band(s) comprises (each) a radially outermost edge which forms part of an outer periphery of the propeller.

25. The cleaning device according to claim 24, wherein the radially outer parts connected with the connection band(s) comprise radially outermost edges which together with the radially outermost edge(s) of the connection bands form the outer periphery of the propeller.

26. The cleaning device according to claim 21, claims wherein the minimum distance between at least one of the leading edges and the nozzle opening(s) measured parallel to a plane perpendicular to the longitudinal axis of the rotary shaft is smaller than the minimum distance between the trailing edge and the nozzle opening(s) measured parallel to a plane perpendicular to the longitudinal axis of the rotary shaft.

27. The cleaning device according to claim 21, wherein the nozzle unit comprises at least two separate nozzles arranged in a radial distance from the longitudinal axis of the rotary shaft, said device comprises at least one shaft pipe section extending through the rotary shaft and one or more nozzle pipe section connecting the shaft pipe section to the nozzles.

28. The cleaning device according to claim 21, wherein the nozzle moves along a nozzle rotation circle when it rotates about the rotary shaft, the nozzle has a jet direction determined as the center axis of the exit channel of the nozzle adjacent to the nozzle opening, said jet direction is parallel to a tangent plane to said nozzle rotation circle, such as with an angle to the nozzle rotation circle of from about 1 degree to about 85 degrees, such as from about 5 degrees to about 45 degrees.

29. The cleaning device according to claim 21, wherein the nozzle is located within the outer periphery of the propeller.

30. The cleaning device according to claim 21, wherein the nozzle is integrated with the propeller.

31. The cleaning device according to claim 21, wherein the first plate and the second plate of the vane are angled with an angle V in relation to each other, said angle V is mainly from about 100 degrees to about 170 degrees, such as from about 110 degrees to about 160 degrees, preferably said angle V being selected in dependence of a selected power of the device determined as the pressure P of water ejected via the nozzle(s), such that the larger the pressure P, the larger the angle V.

32. The cleaning device according to claim 21, wherein at least one of the trailing edge and the leading edge of the vane is substantially straight, preferably at least one of the trailing edge and the leading edge of the vane are substantially radially directed from the longitudinally axis of the rotary shaft.

33. The cleaning device according to claim 21, wherein the leading edge(s) comprises a cutting edge adapted to cutting debris to pieces.

34. The cleaning device according to claim 21, wherein the height h1 between the leading edge and the neighboring trailing edge varies in dependence of the distance to the longitudinal axis of the rotary shaft, mainly the height h1 between the leading edge and the neighboring trailing edge increases with the distance to the longitudinal axis of the rotary shaft.

35. The cleaning device according to claim 21, wherein it further comprises a housing containing at least a part of the propeller, the rotating shaft and/or the nozzle unit.

36. The cleaning device according to claim 21, wherein the housing comprises a first protection plate covering the front surface of the vane(s), said protection plate comprising openings for allowing fluid communication into the housing and through the first opening(s) of the cleaning device.

37. A method for cleaning an underwater surface, the method comprising providing a cleaning device as defined in anyone of the preceding claims wherein the method comprises arranging the cleaning device with its vane front surface facing the surface to be cleaned, jetting water via the nozzle(s) towards the surface while simultaneously rotating the propeller such that debris attached to the surface are released, and said released debris are led through the first opening(s) located between the leading edge of one vane and the trailing edge of the neighboring vane, by a water stream generated by the rotation of the propeller.

38. The method according to claim 37, wherein the said jetting of water via the nozzle(s) towards the surface results in a first force and said cleaning device is held such that a second force acting against the first force is achieved, said second force is provided by said rotation of the propeller.

39. The method according to claim 37, wherein said leading edge comprises a cutting edge, said method comprises cutting debris to pieces.

40. The method according to claim 37, wherein the surfaces to be cleaned is a surface under or close to water such as surfaces of ships, pontoons for net belonging to fish farming in the ocean.
